(19) United States
(12) Patent Application Publication
(10) Pub. No.: US 2023/0027152 A1
(43) Pub. Date: Jan. 26, 2023

(54) UPGRADE OF NETWORK OBJECTS USING SECURITY ISLANDS

(71) Applicants: Kshitij Arun Doshi, Tempe, AZ (US); Francesc Guim Bernat, Barcelona (ES); Ned M. Smith, Beaverton, OR (US)

(72) Inventors: Kshitij Arun Doshi, Tempe, AZ (US); Francesc Guim Bernat, Barcelona (ES); Ned M. Smith, Beaverton, OR (US)

(21) Appl. No.: 17/956,517

(22) Filed: Sep. 29, 2022

(51) Int. Cl. H04L 41/082; H04L 41/0654; H04L 9/40

(52) U.S. Cl. CPC H04L 41/082; H04L 41/0672; H04L 63/08

(57) ABSTRACT

Systems and techniques to upgrade network objects using security islands are described herein. Security islands of node groupings are created based on trust relationships between nodes in an edge network. An upgrade request may be received to upgrade a target edge node in the edge network. Building blocks may be identified for a package installed on the target edge node to be upgraded. A state backup may be stored for the building blocks. An upgrade command and an upgrade payload may be transmitted to the target edge node. The target edge node may be queried to obtain a status of the target edge node. An upgrade action may be determined based on the status and the upgrade action may be executed.

### TECHNICAL FIELD

Embodiments described herein generally relate to edge network systems maintenance and, in some embodiments, more specifically upgrading network objects of an edge network using security islands.

### BACKGROUND

Data center clouds furnish resources with emerging elastic edge cloud architectures. Vehicle-to-everything (V2X), vehicle-to-vehicle (V2V), and smart city technologies are expanding and define new challenges for edge cloud infrastructures. Total cost of ownership (TCO) is a problem in scalable edge to cloud infrastructure because key performance indicators (KPI) anticipate high assurance low latency access to data. Small cell and cell base stations may communicate with a central office and cloud infrastructures requiring efficient, scalable, and manageable operation of the edge network infrastructure. Edge architectures may scale to thousands or hundreds of thousands of edge nodes that are distributed across the Edge infrastructure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7A provides an overview of example components for compute deployed at a compute node in an edge computing system.

FIG. 7B provides a further overview of example components within a computing device in an edge computing system.

FIG. 7C illustrates an example software distribution platform to distribute software to one or more devices.

FIG. 8 is a block diagram of an example of an edge computing infrastructure with resource, latency, and use case requirements to upgrade network objects using security islands, according to an embodiment.

FIG. 9 illustrates an example of use cases in which an edge network may be deployed to upgrade network objects using security islands, according to an embodiment.

FIG. 10 is a block diagram of an example of a system to upgrade network objects using security islands, according to an embodiment.

FIG. 11 illustrates an example of a process for upgrade of a node by a trusted remote edge node and a set of failover trusted nodes, according to an embodiment.

FIG. 12 illustrates an example of as process for node upgrade failover, according to an embodiment.

FIG. 13 illustrates an example of an architecture for a node acting as target node to upgrade network objects using security islands, according to an embodiment.

FIG. 14 illustrates an example of an architecture for a node acting as an upgrade edge node or a failover edge node to upgrade network objects using security islands, according to an embodiment.

FIG. 15 illustrates an example of a method for upgrading network objects using security islands, according to an embodiment.

### DETAILED DESCRIPTION

Life cycle management for each edge location may dictate the extent of available edge scalability. System upgrades may have any impact on performance aspects and system upgrades (hardware and software) should be scalable, transparent, and reliable. Some edge architectures aim to deploy highly distributed edge infrastructure in constrained locations. For example, connectivity to the backhaul or tier (e.g., infrastructure orchestration) where the control plane resides may not be continuous. Hence, during certain intervals connectivity may be interrupted. In another example, latency to the backhaul may be significant. For instance, connectivity to the control plane for some deployments may include satellites (e.g., geosynchronous equatorial orbit (GEO), low Earth orbit (LEO), etc.). Consequently, certain actions (e.g., monitoring and error mitigation) via the backhaul may have high latencies (e.g., up to six seconds, etc.). In yet another example, resiliency of the backhaul may affect operations of a far edge. In some cases, the control plane may be hosted at intermediate tiers that may experience transient failures or connectivity loss. For instance, edge deployments at a telecommunications provider may have an intermediate infrastructure management entity that resides in a data center located between base stations and central offices.

In a centralized system, upgrading edge network components across edge locations is a challenge. Upgrades may be applied without the dependency on a backhaul. The systems and techniques discussed herein use decentralized strategies for edge infrastructure upgrades. Edge peers participate in implementation of system upgrades where the edge peers form a hive to perform monitoring and failover response.

In some edge infrastructure techniques, management updates are performed remotely with an assumption of direct and reliable connectivity between a control plane performing the update and a data plane handling a variety of workloads deployed as a network backhaul. Therefore, resiliency of system upgrades relies on connectivity quality (e.g., bandwidth, reliability, etc.) resulting in low reliability for deployments that have poor quality or intermittent connectivity, higher operating expense due to a higher probability of failures during upgrades, and low scalability.

The systems and techniques discussed herein address resiliency issues in system upgrades by enabling a resilient edge computing infrastructure that facilitates decentralized system upgrades. A protocol is used for initiating, completing, continuing, and discontinuing transactionally ordered upgrades that is deadlock-free. The protocol is responsive to capabilities and limitations of network nodes. Upgrade operations are proxied through a system of backup provisioning nodes where reachability characteristics determine which node(s) act as a tether for provisioning updates and performing other resiliency duties that improve node stability and ensure secure points of operation.

The architecture realizes system upgrades via a hive of edge peers (e.g., base stations, etc.) that perform upgrades collaboratively. For a given system X, an upgrade is performed by a set of peers Y and Z. Peer Y may be responsible for monitoring and upgrading various system X elements while the Z peer may function as a failover twin in cases where the main system (Y) fails or is unable to complete the upgrade.

The systems and techniques discussed herein enable wide deployment of edge computing and allow additional edge content providers to contribute to a federated edge computing infrastructure. For example, in addition to expanding the access for telecommunication providers, content service platforms (CSPs), and hyperscalers (e.g., infrastructure-as-a-service (IaaS) providers, etc.) an ability to roam services may expand to other enterprises that own edge data centers inclusively and in a streamlined manner. The systems and techniques discussed herein increase availability of green-powered utilization, scalability, and resiliency for edge network participants by implementing scale upgrades in a more resilient way, thereby reducing total cost of ownership (TCO).

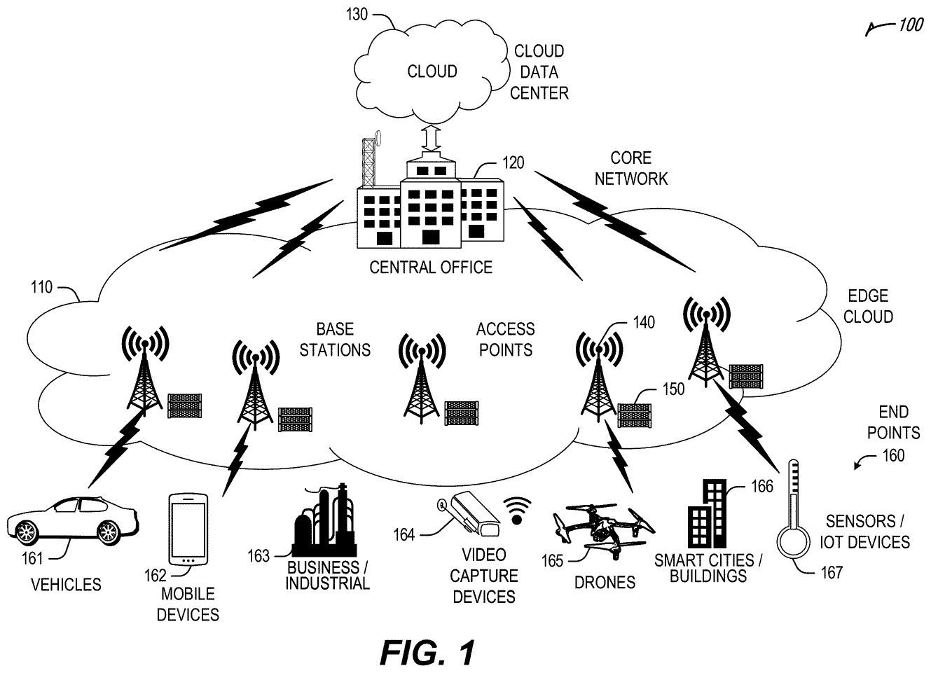

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

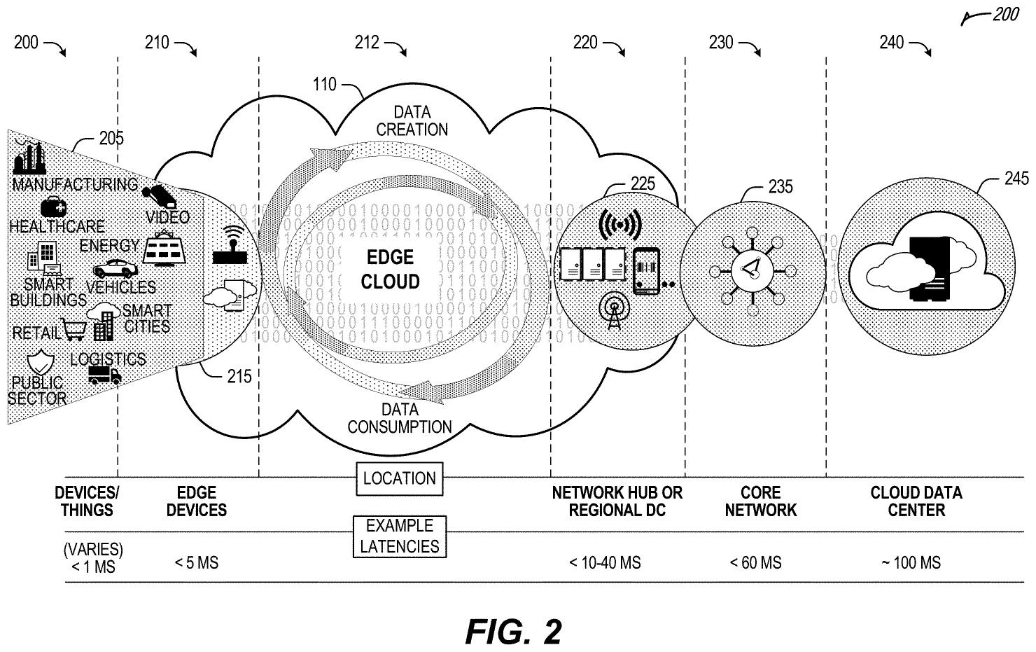

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, content service platform (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

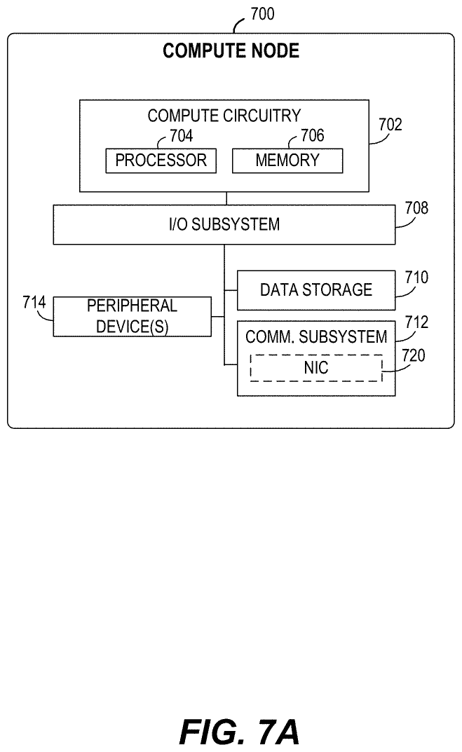

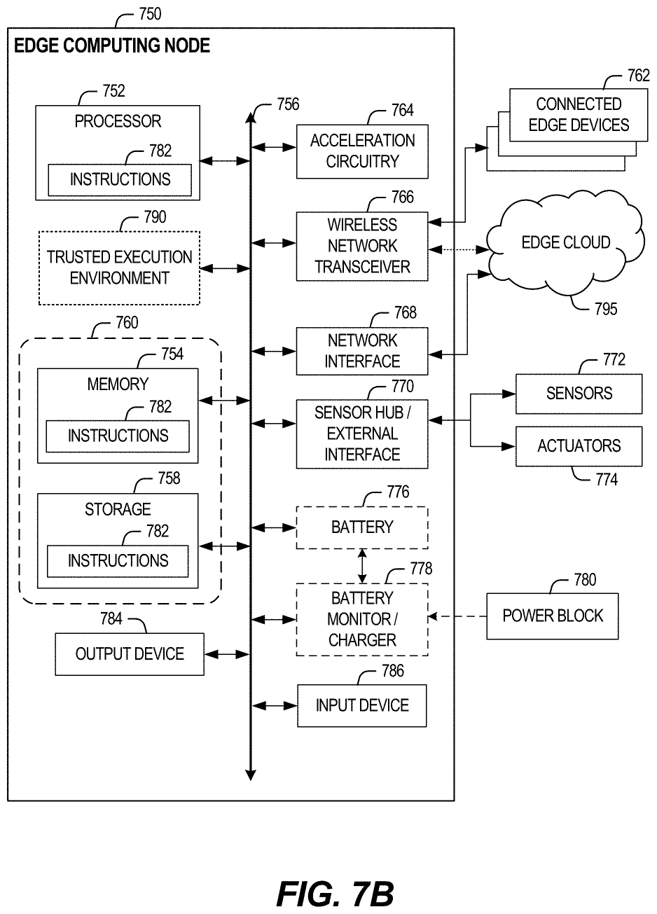

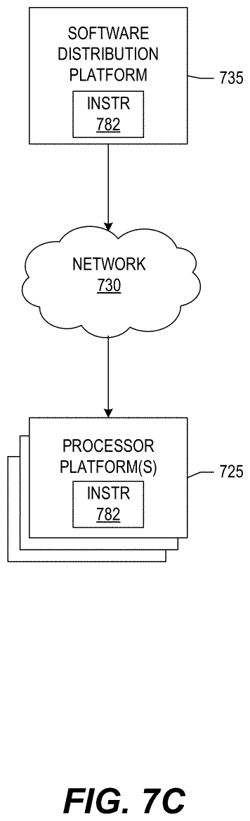

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

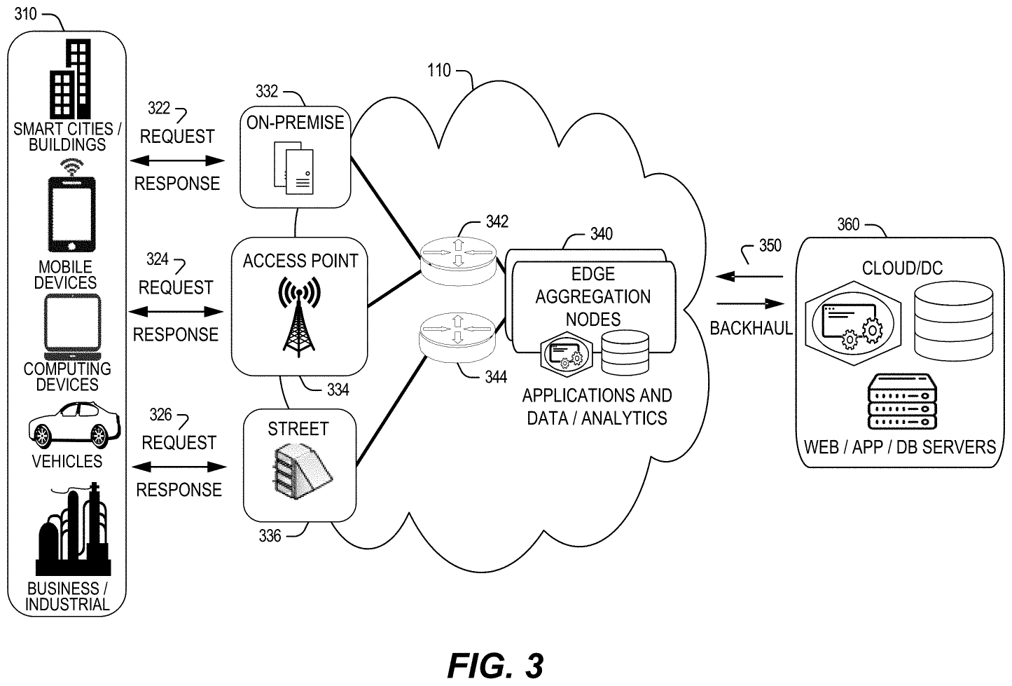

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

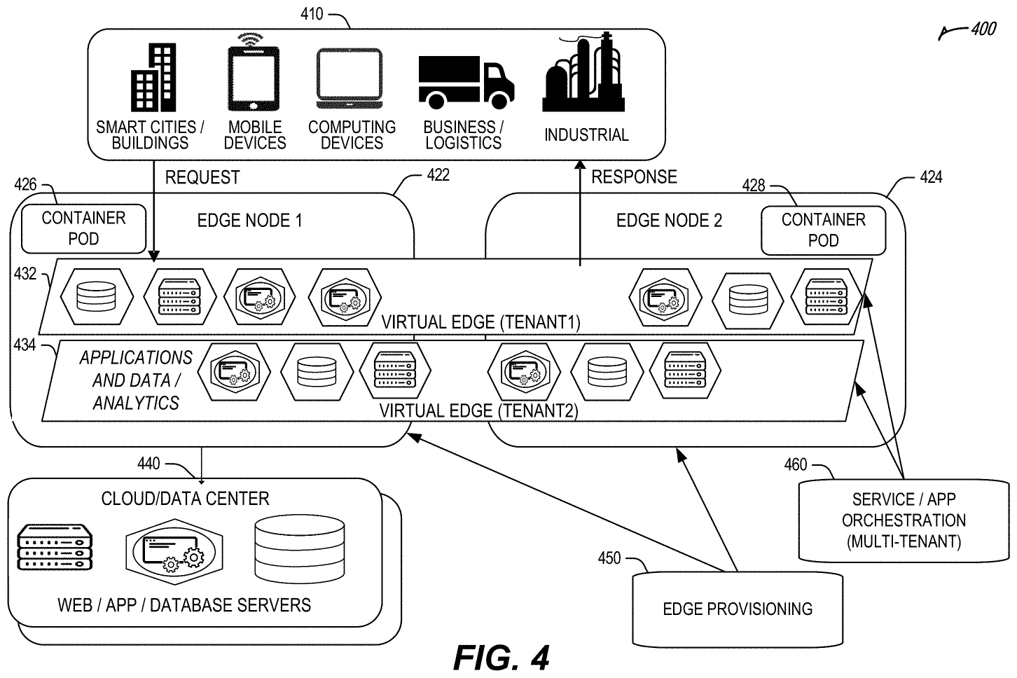

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities / building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

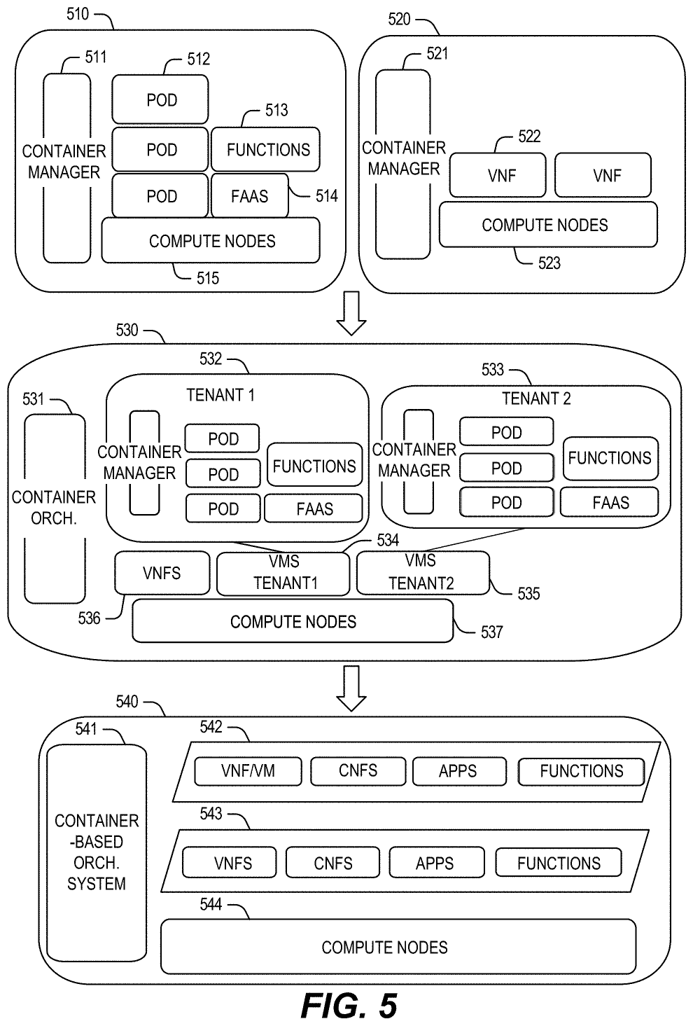

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

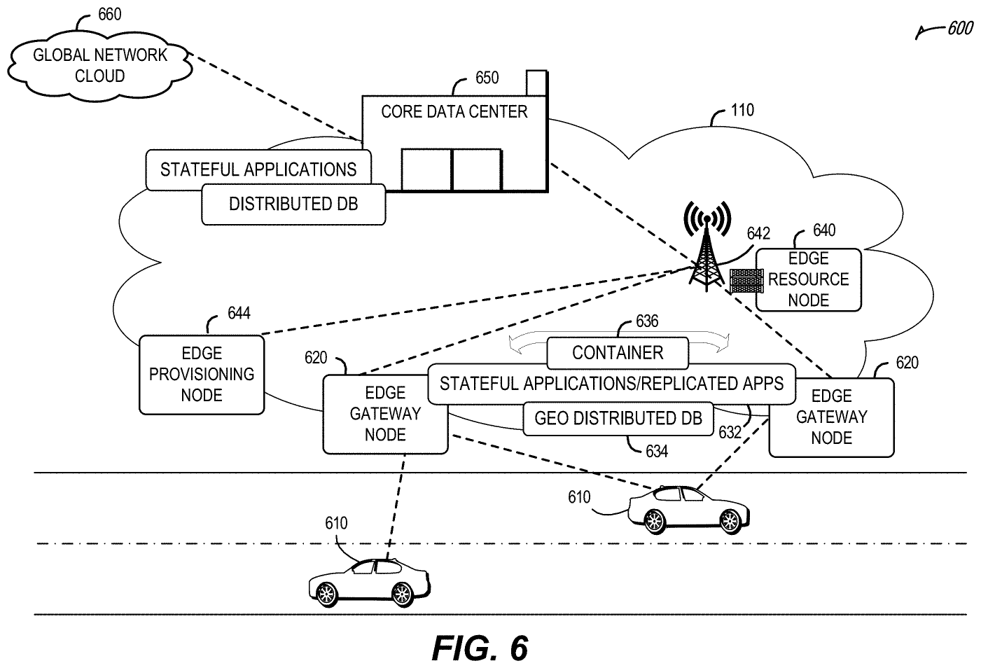

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). In an example, an IPU is a programmable networking device that may be configured to execute instructions stored in memory and executed by a processor to provide networking functions via a network interface. Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). Types of DRAM that may be used in a memory module include synchronous dynamic random access memory (SDRAM) and magnetoresistive random-access memory (MRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX), Intel® Trust Doman Extensions (TDX), or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

FIG. 7C illustrates an example software distribution platform 735 to distribute software, such as the example computer readable instructions 782 of FIG. 7B, to one or more devices, such as example processor platform(s) 735 and/or example connected Edge devices 310 of FIG. 3. The example software distribution platform 735 may be implemented by any computer server, data facility, cloud service, etc., capable of storing and transmitting software to other computing devices (e.g., third parties, the example connected Edge devices 310 of FIG. 3). Example connected Edge devices may be customers, clients, managing devices (e.g., servers), third parties (e.g., customers of an entity owning and/or operating the software distribution platform 735). Example connected Edge devices may operate in commercial and/or home automation environments. In some examples, a third party is a developer, a seller, and/or a licensor of software such as the example computer readable instructions 782 of FIG. 7B. The third parties may be consumers, users, retailers, OEMs, etc., that purchase and/or license the software for use and/or re-sale and/or sub-licensing. In some examples, distributed software causes display of one or more user interfaces (Uls) and/or graphical user interfaces (GUIs) to identify the one or more devices (e.g., connected Edge devices) geographically and/or logically separated from each other (e.g., physically separated IoT devices chartered with the responsibility of water distribution control (e.g., pumps), electricity distribution control (e.g., relays), etc.).

In the illustrated example of FIG. 7C, the software distribution platform 735 includes one or more servers and one or more storage devices. The storage devices store the computer readable instructions 782, which may correspond to the example computer readable instructions, as described above. The one or more servers of the example software distribution platform 735 are in communication with a network 730, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or via a third-party payment entity. The servers enable purchasers and/or licensors to download the computer readable instructions 782 from the software distribution platform 735. For example, the software, which may correspond to the example computer readable instructions, may be downloaded to the example processor platform(s) 735 (e.g., example connected Edge devices), which is/are to execute the computer readable instructions 782 to implement the upgrade of network objects using security islands. In some examples, one or more servers of the software distribution platform 735 are communicatively connected to one or more security domains and/or security devices through which requests and transmissions of the example computer readable instructions 782 must pass. In some examples, one or more servers of the software distribution platform 735 periodically offer, transmit, and/or force updates to the software (e.g., the example computer readable instructions 782 of FIG. 7B) to ensure improvements, patches, updates, etc., are distributed and applied to the software at the end user devices.

In the illustrated example of FIG. 7C, the computer readable instructions 782 are stored on storage devices of the software distribution platform 735 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 782 stored in the software distribution platform 735 are in a first format when transmitted to the example processor platform(s) 735. In some examples, the first format is an executable binary in which particular types of the processor platform(s) 735 can execute. However, in some examples, the first format is uncompiled code that requires one or more preparation tasks to transform the first format to a second format to enable execution on the example processor platform(s) 735. For instance, the receiving processor platform(s) 735 may need to compile the computer readable instructions 782 in the first format to generate executable code in a second format that is capable of being executed on the processor platform(s) 735. In still other examples, the first format is interpreted code that, upon reaching the processor platform(s) 735, is interpreted by an interpreter to facilitate execution of instructions.

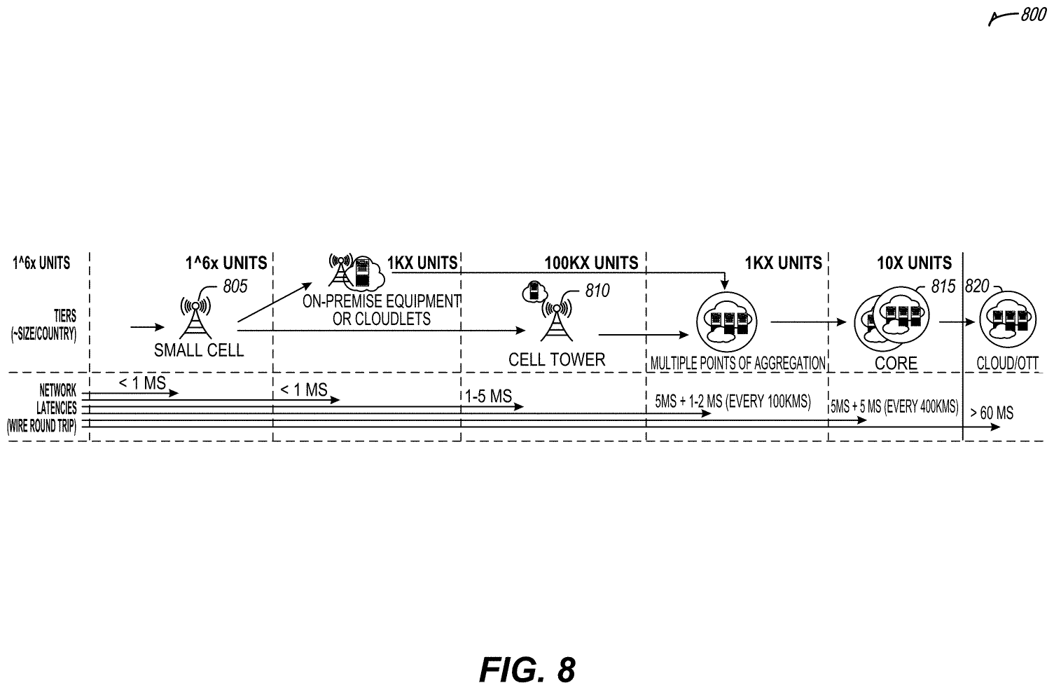

FIG. 8 is a block diagram of an example of an edge computing infrastructure 800 with resource, latency, and use case requirements to upgrade network objects using security islands, according to an embodiment. Total cost of ownership (TCO) is an issue with scalable edge to cloud infrastructure because key performance indicators (KPI) anticipate high assurance low latency access to data. Small cell 805 and cell base stations 810 may communicate with central office 815 and cloud infrastructures 820 to be efficient, scalable, and manageable. Edge architectures may scale to thousands or hundreds of thousands of edge nodes that are distributed across the edge infrastructure.

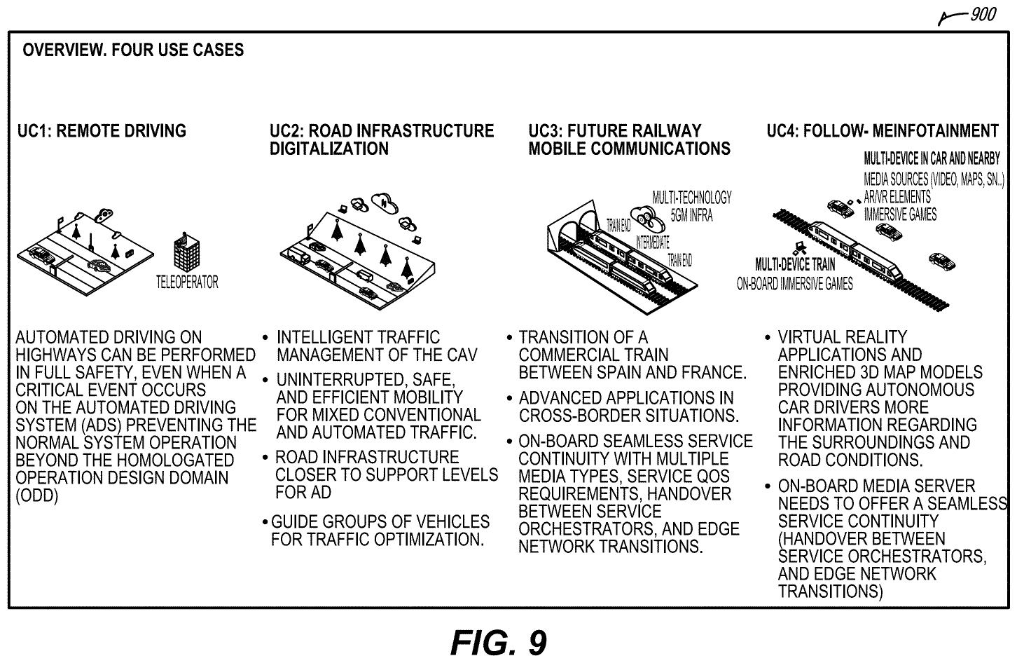

FIG. 9 illustrates an example of use cases 900 in which an edge network may be deployed to upgrade network objects using security islands, according to an embodiment. An edge network, in some examples, may include more than 35,000 kilometers of compute fabric. Resilient scalable system upgrade may be used to ensure reliable update and upgrade of network components. The infrastructure may be updated incrementally because connectivity to a backhaul may be achieved via low Earth orbit (LEO) satellites where intermittent connectivity results from weather, sunspot activity, and receiver and satellite placement. Green energy is increasingly making inroads including an increase in solar energy where edge infrastructure power may be less reliable due to weather conditions. Consequently, periodic system failure or loss of energy may also impact connectivity.

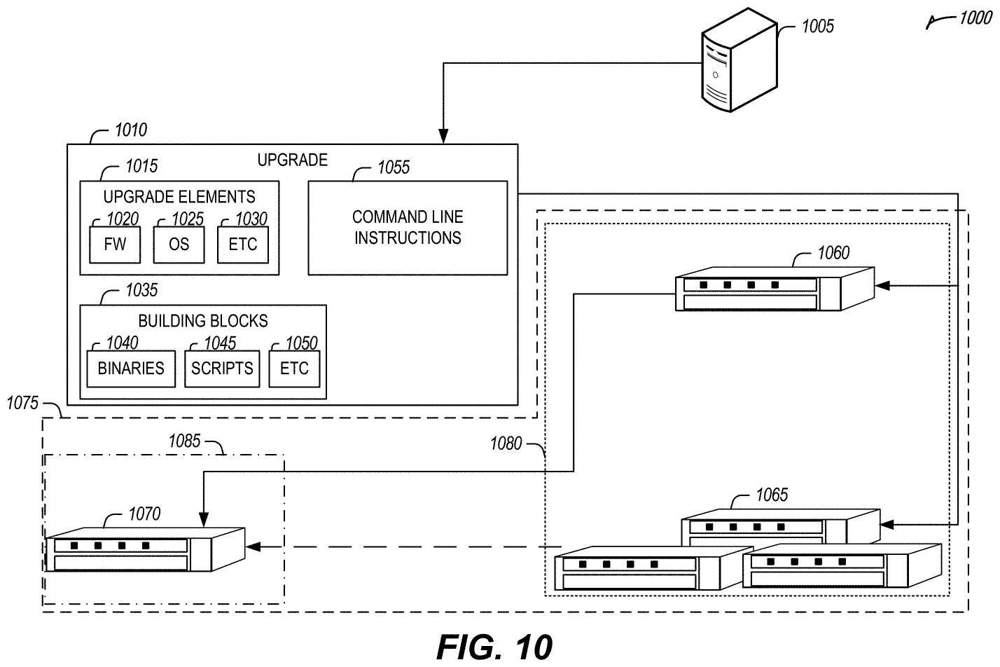

FIG. 10 is a block diagram of an example of a system 1000 to upgrade network objects using security islands, according to an embodiment. The system 1000 may provide features as described in FIGS. 8 and 9. The system 1000 may include an infrastructure orchestrator 1005, that transmits a system upgrade 1010 to an upgrade edge node 1060 and one or more failover nodes 1065.

The infrastructure orchestrator 1005 runs on a backhaul of an edge network. In an example, the infrastructure orchestrator 1005 may be a centralized software entity. For example, the infrastructure orchestrator 1005 may be hosted in a network cloud service. The infrastructure orchestrator 1005 initiates system upgrades for a particular edge node.

The system upgrade 1010 may include a set of elements to be upgraded 1015 (e.g., firmware (FW) 1020, operating system (OS) 1025, etc. 1030), a set of building blocks 1035 to be copied (e.g., binaries 1040, scripts 1045, etc. 1050) that correspond to target elements, and a set of command line instructions 1055 that execute during application of the upgrade. In an example, the system upgrade may include a payload that includes update commands. In an example, the payload may be transmitted to a target node at the time of update. In an example, the payload may be transmitted to the target node at a time prior to the update and the payload may be executed during the update. For example, the payload may be transmitted to the target node during a period of decreased network traffic on the edge network and may be executed during an update during a period of inactivity for the target node.

A set of peer edge nodes that include the upgrade edge node 1060 and the one or more failover edge nodes 1065 upgrade a target edge node 1070. The target edge node 1070 receives system upgrades and is an edge system to which the system upgrade 1010 is applied. The set of peer edge nodes may be in physical or logical proximity to the target edge node 1070 and may form a “security island” of trusted edge nodes that work cooperatively to ensure resilient deployments of system upgrades for a set of edge nodes for which the set of peer edge nodes are responsible. As used herein, a “security island” is set of platforms that trust each other. Each of the platforms is able to authenticate any of the other peers in the security island that are capable of performing an upgrade. TDX, SGX, TrustZone, and other similar technologies are the building block technologies for creating security islands. These technologies may be embedded in a variety of xPUs (e.g., IPUs, CPUs, GPUs, etc.). Security islands may be expanded to the cloud as well for example, in a platform hosted on the cloud. The upgrade edge node 1060 performs the upgrade and may interact with, execute, instantiate, or initiate multiple building blocks per node. The one or more failover edge nodes 1065 are associated with the upgrade edge node 1060 and will take over the upgrade process if the upgrade edge node 1060 fails to make progress in applying the upgrade to the target edge node 1070. Additionally or alternatively, the one or more failover nodes 1065 identify that the upgrade edge node 1060 has failed and may reassign an upgrade role to another node (e.g., one of the one or more failover edge nodes 1065, another node in the edge network, etc.).

At different times, security islands may be placed in different groupings. Each grouping is associated with a backend virtual private network (VPN) that spans the security islands that comprise that grouping. The groupings are domains of trust, whose trust parameters such as, the network encryption strength, the types of authentication protocols to be employed, the rate at which symmetric keys may be mutated or renegotiated, the types of security or resiliency sensitive events that must be logged, the granularity at which auditable telemetry needs to be collected, etc., are enforced on the VPN.

Trust parameters may be described as a profile or policy of the trust domain. Any resource of a security island may be provisioned with a trust policy that may be applied or enforced for any interaction with other nodes, resources interacting with the security island, or as part of onboarding nodes, resources into the security island. A collection of security islands that enforces the same trust policy may form a VPN of islands. Enforcement points may exist within the VPN, islands, or nodes that challenge and verify compliance to the policy. For example, a VPN router node may require that access to the network be subject to proof of compliance to the policy through attestation or by producing an unexpired token granting access. Similarly, resources within a security island/node may be subject to access control that is based on the trust policy as a condition of a resource becoming discoverable by other nodes, pods, containers, processes, etc. in the island. The trust policy is stored in secure storage that is first allocated to the security island/domain. This means only existing members of the island/domain are authorized to setup/configure secure storage for other nodes/resources being onboarded into the island/domain and for off-boarding/removing the resource from the island/domain.

The same security island may be concurrently in one or more such trust domains. The requirements of communication between a security island and each of its peer security islands in the different trust domains A, B, C, etc. are met by the backend VPN that links that security island into the respective trust domains A, B, C, etc.

From the perspective of managed secure storage containing trust domain policies, a shared domain may require allocation of a separate/new secure storage area containing merged and/or excluded policies from the respective shared trust domains. For example, if trust domain A and B agree to collaborate by allocating a shared trust domain (AB), then the amalgamation of the domain A policy with the domain B policy is formed as the domain AB policy. The AB policy is stored in its own secure storage resource and a security island may be formed having shared resources between domains A and B. These resources may be onboarded into the security island in similar fashion as described above. Resources that have been onboarded into security islands may produce a log describing the resource and which island successfully onboarded the resource. Onboarding logs may be queried as part of a next onboarding to determine which resources are shared (previously onboarded and not yet off-boarded) as a condition of entry into a next security island/domain. Access control grants, tokens, tickets, permissions etc. may use onboarding logs to determine whether an application, user, workload, or other subject is at risk of downgrade attack due to cross-domain sharing of resources. Grant of such access may be contingent on or restricted by the islands/domains with which the subject may interact. For example, a token granted to workload A might restrict access to domains A and C such that if a shared security island consisting of B and C is accessed, the token would prevent interaction with B resources. The security island enforcement point may determine that the access permission cannot be guaranteed for policy BC and may restrict access to resources with policy C only (not BC).

Further, some trust domains may be established once and used continuously for supporting various high-availability usages which also require timely dissemination and synchronization of updates. Further for example, some other trust domains may be ephemeral: these may be formed dynamically over time and dissolved dynamically over time, in order to free up overlay resources and in order to limit vulnerability. A durable trust domain may be set up also for mobile datacenters, or between satellite borne and terrestrial hubs, so that continuity of operation is maximized by reducing the time it takes to constitute and activate update operations in an ephemeral domain. An ephemeral trust domain may be set up a short time before a workload bursts from one cloud/edge-cloud provider and another cloud/edge-cloud provider to ensure that all security islands that are going to bear the execution of workloads that are being orchestrated multi-cloud (e.g., for elasticity), multi-geo (e.g., for latency and data privacy), etc., are at the identical level of updates. When such multi-cloud or multi-geo operations complete, the ephemeral trust domains may also be dissolved.

For example, the upgrade edge node 1060, the target node 1070, and the failover edge nodes 1065 may be members of a group 1075. The security islands in the group 1075 may be in a first trust domain 1080 of which the upgrade edge node 1060 and failover edge nodes 1065 are members and in a second trust domain 1085 of which the target edge node 1070 is a member. Thus, the first trust domain 1080 and the second trust domain 1085 share a policy for the security islands in the group 1075 that grants them access to perform upgrades and updates across the security boundaries of their respective trust domains. The trust domains and security island may be durable or ephemeral based on the policies established for the security island and the trust domains. For example, the security islands in group 1075 may be established upon receipt of a new update package and may include members in authorized trust domains that have a service component that is a subject of the new update package while the first trust domain 1080 may be remain in place for secure delivery of services within the edge network.

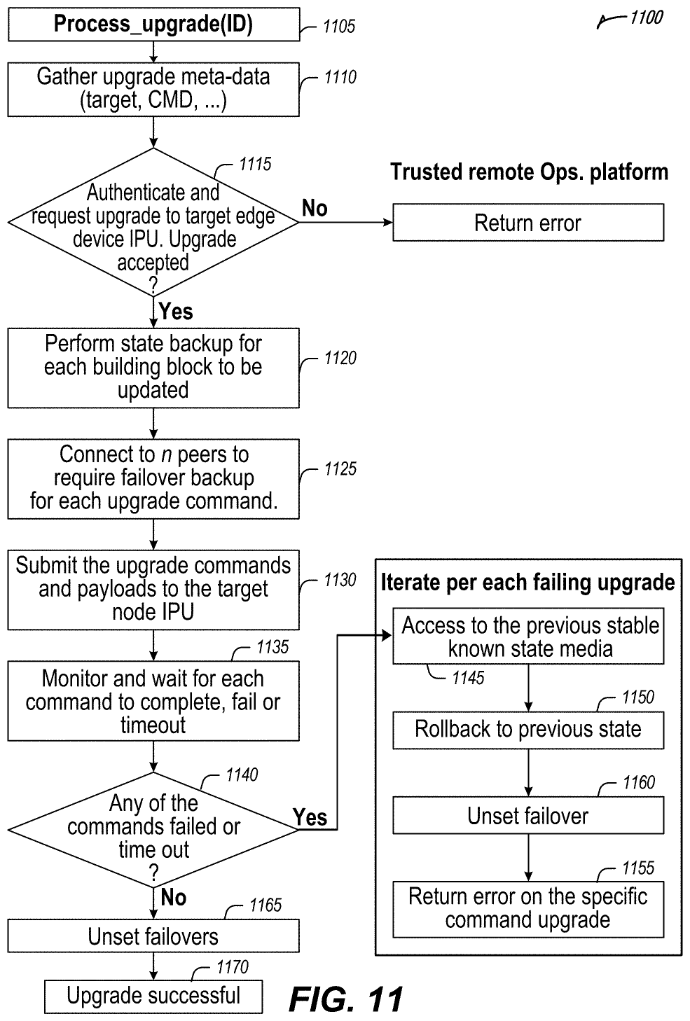

FIG. 11 illustrates an example of a process 1100 for upgrading a node by a trusted remote edge node and a set of failover trusted nodes, according to an embodiment. The process 1100 may provide features as described in FIGS. 8 to 10.

The process 1100 may be performed by an edge node responsible for upgrades (e.g., the upgrade edge node 1060 as described in FIG. 10, etc.). Two or more edge nodes may have the responsibility of performing an upgrade of a target edge node (e.g., the upgrade edge node 1060 and the one or more failover nodes 1065 as described in FIG. 10, etc.). An upgrade operation may include a set of upgrade actions that affect different building blocks of the same target edge node. Upgrade actions may be performed by executing a set of commands that initiate, execute, instantiate, compile, or interact with a set of software assets to be updated. For example, the set of building blocks (e.g., the set of building blocks 1035 as described in FIG. 10) are images used to update the target edge node (e.g., the set of elements to be upgraded 1015 as described in FIG. 10).

The upgrade edge node receives a request from a backhaul server/service to perform an upgrade with a particular identifier (e.g., at operation 1105). Before execution of the upgrade, the upgrade is assigned to a hive of nodes in the same security island (e.g., including the upgrade edge node, etc.) that will deliver upgrades (e.g., at operation 1110). The definition includes commands and an upload of software elements of the upgrade.

The upgrade edge node connects to the target edge node to be upgraded and notifies the target edge node that the action is going to take in place including a handshake for authentication and authorization of the upgrade (e.g., at decision operation 1115). If the authentication fails, an error is returned to the upgrade edge node and the process 1100 terminates.

The upgrade edge node creates a backup for each building block to be upgraded to preserve an ability to perform a rollback to the existing software if needed (e.g., at operation 1120). The state of each building block may be stored locally on the upgrade edge node or stored in a data lake appliance. A data lake appliance is a storage service (like a storage area network (SAN)) deployed in Edge networks. The set of building blocks 1035 described in FIG. 10 are readily available due to their location in the Edge/data lake. Upgrades may occur quickly and efficiently as a consequence of the storage locality.

The upgrade edge node notifies failover edge nodes that an upgrade is about to begin and supplies the upgrade identifier to the failover edge nodes (e.g., at operation 1125). The failover edge nodes observe the upgrade process for the target edge node. Failover edge nodes are “digital twin” environments such as a pair of virtual machines (VMs), pair of SGX enclaves, or pair of TDX domains. The hypervisor/time-division multiplexer (TDM) ensures the paired environments maintain consistent state across each twin. This applies to update as well, where the update may be applied to one twin, cross-checked by the other, then the other twin updated.

The upgrade edge node begins the upgrade for each building block element and sends the upgrade commands (e.g., at operation 1130) and waits until the commands have executed or a time out has occurred (e.g., at operation 1135).

In case of time out or failure for a particular building block (e.g., as determined at decision operation 1140), the upgrade edge node requests rollback of the target edge node for a given update and the upgrade edge node provides a rollback state to the target edge node (e.g., at operations 1145 and 1150). A connection to peers (e.g., at operation 1125) establishes failover nodes so that if the update fails, the node may failover to one of the failover nodes. If the update is successful (e.g., at operation 1170) or if the rollback is successful (e.g., at operation 1155), then a normal state is identified and the failover backup nodes are released (e.g., disconnected, etc.). The upgrade edge node notifies each failover edge node of failure (e.g., at operation 1140) or success (e.g., at operation 1170) for a given building block element to ensure consistent state tracking of the upgrade.

When statuses have been cleared (e.g., at operations 1160 and 1165) , the state of the upgrade is stored and the backhaul is notified and the failover edge nodes are notified that the given upgrade has been finalized and it is determined that the upgrade was successful (e.g., at operation 1170).

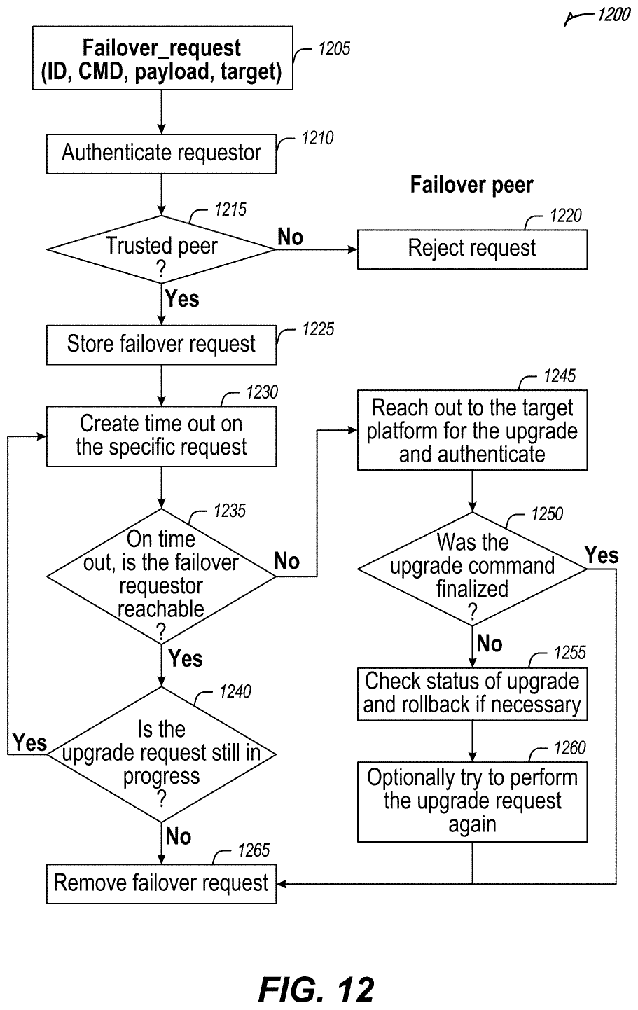

FIG. 12 illustrates an example of as process 1200 for node upgrade failover, according to an embodiment. The process 1200 may provide features as described in FIGS. 8 to 11.

Failover edge nodes are responsible for tracking a main upgrade edge node and ensuring the upgrade edge node does not fail to apply an upgrade to a target edge node. If the upgrade edge node fails, the failover edge nodes perform the upgrade. There may be many causes for a failure event. For example, a power glitch, a communication failure, solar flares, security attacks, logic errors, etc. may cause an upgrade to fail. If a failure occurs (and no recovery was found) then failover logic operations are triggered (e.g., at decision 1140 as described in FIG. 11).

A failover edge node in the security island may receive a failover request from the upgrade edge node that may include an upgrade identifier, upgrade commands, an upgrade payload, and a target edge node identifier (e.g., at operation 1205). In an example, the failover edge node may be the first failover edge node in the security island to respond to the failover request, may be elected as the primary failover edge node, etc. In an example, a manual failover may be caused to occur. For example, an administrator may be aware of an issue with a current image and may force it to transition to the failover image as a way of migrating to the failover environment. This should occur only if authorized by establishing a trusted peer. The failover edge node may authenticate the requestor (e.g., the upgrade edge node) to validate that the upgrade edge node is a trusted node (e.g., at operation 1210). Trust may be determined by using attestation (e.g., via trusted platform module (TPM), device identifier composition engine (DICE), INTEL® software guard extensions (SGX), INTEL® trust domain extensions (TDX), etc.). If untrusted (e.g., as determined at decision operation 1215), the request may be rejected and a different upgrader node is assigned (e.g., at operation 1220). The failover edge node is capable of protecting assets to a similar level of security as the upgrade edge node and vice versa. The upgrade edge node should not transition to a failover node that uses lesser security. Thus, the upgrade edge node and the failover edge node cross-check each other to ensure no security boundaries are being weakened.

If the upgrade edge node is trusted (e.g., as determined at decision operation 1215), then the requests of the failover node are stored and included in a monitoring request table (e.g., at operation 1225). The failover node becomes responsible for monitoring status of the upgrade process applied to the target edge node by the upgrade edge node.

The failover node may program a timeout that triggers monitoring the status of the upgraded target edge node (e.g., at operation 1230). When the time out occurs (e.g., as determined at decision operation 1235), the failover node checks whether the upgrade edge node is alive (e.g., at operation 1235) and that the various pending upgrades are progressing (e.g., at operation 1240). The failover edge node may collect progress status of the upgrade to ensure consistent state of the upgrade (e.g., at operation 1240).

Upon a time out or if no response is received from the upgrade edge node (e.g., as determined at decision operation 1235), the failover node determines the upgrade edge node has failed. The failover node may make several attempts to reestablish connectivity with the upgrade edge node to determine if there is a transient failure. Upon a final decision that a failure has occurred, the failover edge node (or another failover edge node) is promoted to the role of the upgrade edge node (e.g., at operation 1245).

The new upgrade edge node checks the status of the target edge node and the validates the status of the upgrade (e.g., at operation 1250). The new upgrade edge node may rollback upgrades of specific components (e.g., at operation 1255) in case that the previous upgrade edge node failed to apply the upgrades (e.g., as determined at decision operation 1240). The new upgrade edge node may try the upgrade again to check whether it was a problem caused by the original upgrade edge node (e.g., at operation 1260).The new upgrade edge node performs the remainder of the pending upgrade and removes the failover request from the request table (e.g., at operation 1265). The original upgrade edge node and other failover edge nodes may examine the request table to determine that the upgrade has completed. In an example, a success notification may be transmitted to the original upgrade edge node and the other failover edge nodes to indicate that the upgrade was successful and they may continue to provide upgrade services for the security island.

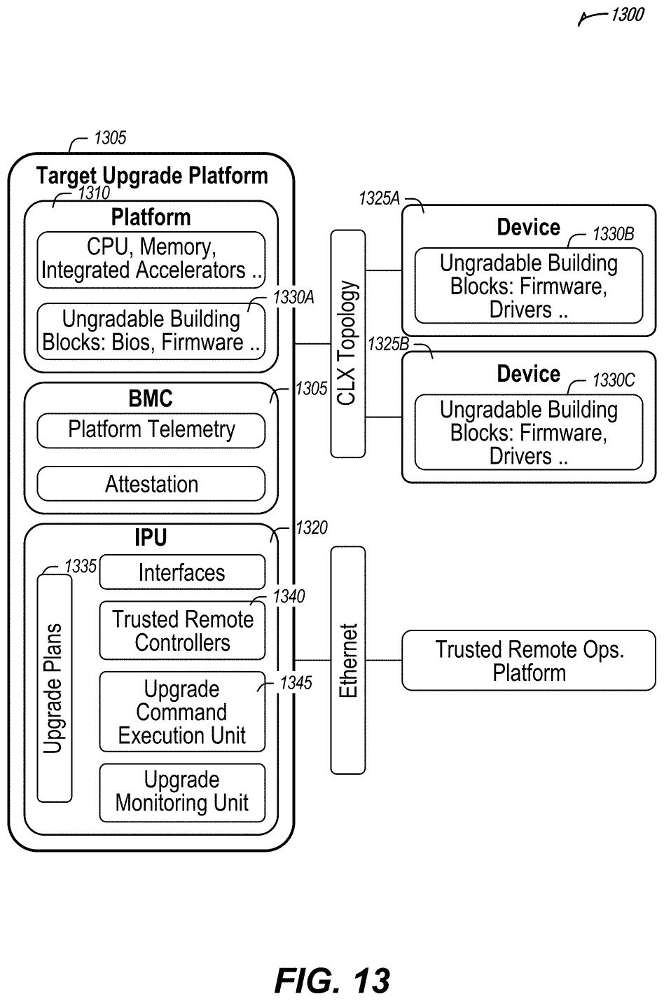

FIG. 13 illustrates an example of an architecture 1300 for a node acting as target node to upgrade network objects using security islands, according to an embodiment. The architecture 1300 may provide features as described in FIGS. 8 to 12.

The architecture 1300 includes a target upgrade platform 1305 (e.g., a target edge node) that may include a platform component 1310, a baseband management controller (BMC) 1315, and an infrastructure processing unit (IPU) 1320.

The IPU 1320 may be connected to an edge node, in a separate power domain, and may be independent from the target upgrade platform 1305. Hence, failures on the target upgrade platform 1305 may not affect the IPU 1320. In an example, the IPU 1320 may remain active during progression of an upgrade while the target upgrade platform 1305 maybe rebooting. Logic in the IPU 1320 may include sub-logic that is executed when a node is acting as the target upgrade platform 1305 and sub-logic that is executed when the node is acting as an upgrade edge node or failover edge node.

The components of the edge system (e.g., the target upgrade platform 1305 and connected discrete devices 1325A and 1325B) may include building blocks 1330A, 1330B, and 1330C that may be targets to be upgraded. For example, a device 1325A may have firmware (FW) as a potentially upgradable building block in its building blocks 1330B. The target upgrade platform 1305 (and the devices 1325A and 1325B) that may be upgraded include application programming interfaces (APIs) and interfaces that may be used by the IPU 1320 to perform an update.

The IPU 1320 includes a set of interfaces that are used to implement the dataflows described in FIGS. 11 and 12 and allow registration of upgrade plans 1335. The IPU 1320 includes a trusted remote controller logic 1340 that is responsible for authentication of upgrade requests. Commands that are issued by a remote upgrade edge node are processed by an upgrade command execution unit 1345. The commands are associated to a given set of software assets that are used by the commands and that have been previously stored in the upgrade plans 1335 logic. An upgrade plan of the upgrade plans 1335, identified with a particular identifier, includes a set of elements to be upgraded and the software payload to be applied during the upgrade process.

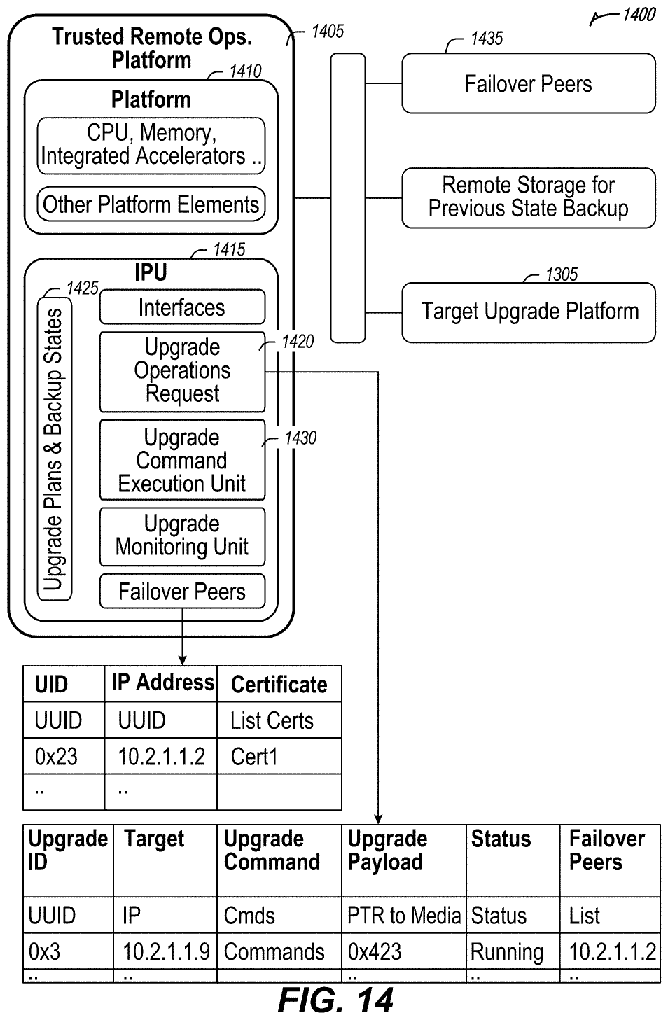

FIG. 14 illustrates an example of an architecture 1400 for a node acting as an upgrade edge node or a failover edge node to upgrade network objects using security islands, according to an embodiment. The architecture 1400 may provide features as described in FIGS. 8 to 13.

The architecture 1400 may include a trusted remote operations platform 1405 (e.g., an upgrade edge node) that may include a platform 1410 and an infrastructure processing unit (IPU) 1415. The IPU 1415 hosts various upgrade requests into upgrade operation request logic 1420. Each of the upgrade requests is associated with an upgrade plan from upgrade plan and backup state storage 1425. The upgrade may include a variety of actions taken to bring a target edge node into compliance with the trusted remote operations platform 1405 configuration. The upgrade plan is stored with a particular ID and includes a set of elements to be upgraded and the software payload to be applied during the upgrade process using logic (that may be implemented using a media internet protocol (IP) block) stores the backup state for each of the elements that is being upgraded in a target edge node in the upgrade plan and backup state storage 1425.

A security island exists when a target upgrade platform is identified (e.g., at operation 1205 of FIG. 12) where a peer trusted remote operations platform 1405 is triggered to perform an upgrade of a target upgrade platform 1305. The trusted remote operations platform 1405 and the target upgrade platform 1305 are peers in a security island because they have similar security properties, policies and configuration. However, the target upgrade platform 1305 is at a back revision and needs to be updated. The trusted remote operations platform 1405 node has current configuration and serves as a template for the upgrade of the target upgrade platform 1305. The security islands act independently of a central authority or management console that in an information technology managed environment would have a management console to manage upgrades.

Upgrade command execution logic 1430 performs a given upgrade following an execution plan for the upgrade. For example, the target edge node may include an IPU and may have an upgrade plan that specifies the upgrade may be performed using execution logic that is specific to the IPU of the target edge node.

Failover peers 1435 are responsible for working with the trusted remote operations platform 1405 on a particular upgrade. This includes the data flows described in FIGS. 11 and 12. While FIGS. 13 and 14 describe separate architectures, the IPU components discussed in FIGS. 13 and 14 are included in the IPUs (e.g., IPU 1320 and IPU 1415) because a node may assume the roles (e.g., target edge node, upgrade edge node, failover edge node) discussed in FIGS. 13 and 14.

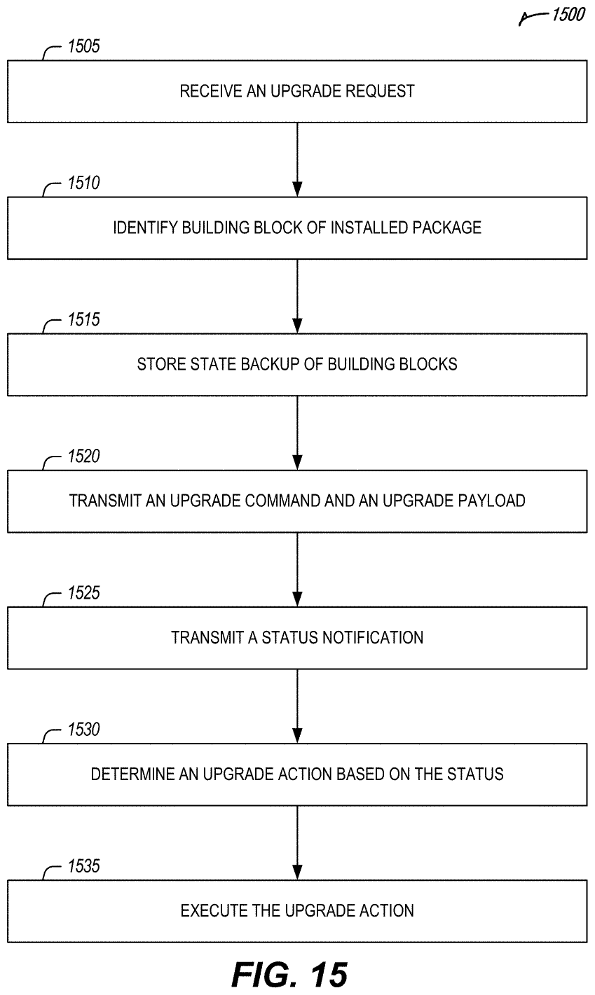

FIG. 15 illustrates an example of a method 1500 to upgrade network objects using security islands, according to an embodiment. The method 1500 may provide features as described in FIGS. 8 to 14.

An upgrade request is received to upgrade a target edge node in the edge network (e.g., at operation 1505). In an example, the upgrade request may include an upgrade identifier.

Building blocks are identified for a package installed on the target edge node to be upgraded (e.g., at operation 1510). In an example, the building blocks may be components of the package. In an example, the upgrade request may be a failover request transmitted by an upgrade edge node of the edge network. The upgrade edge node may be authenticated. The failover request may be stored. An attempt by the upgrade edge node to perform the upgrade may be monitored and the building blocks of the package installed on the target edge node to be upgraded may be identified upon determination that the attempt by the upgrade edge node to perform the upgrade has failed. In an example, it may be determined that the upgrade has completed and the stored failover request may be deleted.

In an example, the determination that the attempt by the upgrade edge node to perform the upgrade has failed may be based on an identification that no response has been received from the upgrade edge node in response to transmission of a status request. In an example, the determination that the attempt by the upgrade edge node to perform the upgrade has failed may be based on a determination that a timeout period has elapsed for receipt of a status update from the upgrade edge node.

A state backup is stored for the building blocks (e.g., at operation 1515). In an example, the state backup may be stored in a storage device of an infrastructure processing unit (IPU) or a programmable networking device. In an example, the state backup of the building blocks includes rollback data to restore the current building block in the event of a failed upgrade attempt.

An upgrade command and an upgrade payload is transmitted to the target edge node (e.g., at operation 1520). In an example, upgrade metadata may be obtained that includes at least an identifier of the target edge node, the upgrade command, and the upgrade payload. In an example, the building blocks may be identified from the upgrade command or the upgrade payload. The upgrade is applied when the node is not processing critical workloads. The target edge node is quiesced before applying the upgrade. In an example, the building blocks may be identified upon a determination that there a no critical workloads executing on the target edge node and the target edge node may be prevented from accepting critical workloads until the status indicates the upgrade has completed.

The target edge node is queried to obtain a status of the target edge node (e.g., at operation 1525). In an example, it may be determined that the upgrade command has timed out. A rollback of a building block may be performed using the state backup and the status notification may include a failure indicator for the building block.

An upgrade action is determined based on the status (e.g., at operation 1530). In an example, the upgrade action executes the upgrade command, performs a rollback of previously installed building blocks using the state backup, set a failover flag, or delete a stored failover request. The upgrade action is executed (e.g., at operation 1535).

In an example, a failover request may be transmitted to a failover node of the edge network that includes an upgrade identifier and an identifier of the target edge node. In an example, the failover edge node and the upgrade edge node are part of a collection of edge nodes that have a trust relationship. In an example, the trust relationship is formed on trust domain extensions (TDX), software guard extensions (SGX), or hardware security extensions. A failover flag may be set for the upgrade of the target edge node. The failover flag may be set to indicate that an upgrade status is unknown because of a potential failure. It may be determined that the upgrade has completed and the failover flag may be unset. Unsetting the failover flag means there is no need to invoke failover because either the upgrade was successful or it was successfully rolled back to the initial state.

### Additional Notes & Examples

Example 1 is a programmable networking device for upgrading network objects in an edge network comprising: processing circuitry configured to: receive, via the network interface, an upgrade request to upgrade a target edge node in the edge network; identify building blocks of a package installed on the target edge node to be upgraded; store a state backup of the building blocks; transmit, via the network interface, an upgrade command and an upgrade payload to the target edge node; query the target edge node to obtain a status of the target edge node; determine an upgrade action based on the status; and cause the upgrade action to be executed on the target edge node.

In Example 2, the subject matter of Example 1 includes, wherein the upgrade request includes an upgrade identifier.

In Example 3, the subject matter of Examples 1-2 includes, processing circuitry configured to obtain upgrade metadata that includes an identifier of the target edge node, the upgrade command, and the upgrade payload.

In Example 4, the subject matter of Examples 1-3 includes, wherein the building blocks are identified from the upgrade command.

In Example 5, the subject matter of Examples 1-4 includes, processing circuitry configured to: authenticate the target edge node; and transmit a request to upgrade to the target edge node, wherein the building blocks are identified upon receipt of a positive response to the request to upgrade.

In Example 6, the subject matter of Examples 1-5 includes, wherein the building blocks are software components of the package.

In Example 7, the subject matter of Examples 1-6 includes, wherein the state backup is stored in a storage device of the programmable networking device.

In Example 8, the subject matter of Examples 1-7 includes, processing circuitry configured to: determine that the upgrade command has timed out; and perform a rollback of a building block using the state backup, wherein the status includes a failure indicator for the building block.

In Example 9, the subject matter of Examples 1-8 includes, processing circuitry configured to: transmit a failover request to a failover node of the edge network, wherein the failover request includes an upgrade identifier and an identifier of the target edge node; set a failover flag for the upgrade of the target edge node; determine that the upgrade has completed; and reset the failover flag.

In Example 10, the subject matter of Examples 1-9 includes, wherein the upgrade request is a failover request transmitted by an upgrade edge node of the edge network and further comprising processing circuitry configured to: authenticate the upgrade edge node; store the failover request; and monitor an attempt by the upgrade edge node to perform the upgrade, wherein the instruction to identify the building blocks of the package installed on the target edge node to be upgraded are executed upon determination that the attempt by the upgrade edge node to perform the upgrade has failed.

In Example 11, the subject matter of Example 10 includes, wherein the processing circuitry configured to determine that the attempt by the upgrade edge node to perform the upgrade has failed further comprises processing circuitry configured to identify that no response has been received from the upgrade edge node in response to transmission of a status request.

In Example 12, the subject matter of Examples 10-11 includes, wherein the processing circuitry configured to determine that the attempt by the upgrade edge node to perform the upgrade has failed further comprises comprising processing circuitry configured to determine that a timeout period has elapsed for receipt of a status update from the upgrade edge node.

In Example 13, the subject matter of Examples 10-12 includes, processing circuitry configured to: determine that the upgrade has completed; and delete the stored failover request.

In Example 14, the subject matter of Examples 1-13 includes, processing circuitry configured to: identify the building blocks upon a determination that there a no critical workloads executing on the target edge node; and prevent the target edge node from accepting critical workloads until the status indicates the upgrade has completed.

In Example 15, the subject matter of Examples 1-14 includes, wherein the state backup of the building blocks includes rollback data to restore the current building block in the event of a failed upgrade attempt.

In Example 16, the subject matter of Examples 1-15 includes, wherein the upgrade action executes the upgrade command, performs a rollback of previously installed building blocks using the state backup, set a failover flag, or delete a stored failover request.

In Example 17, the subject matter of Examples 9-16 includes, wherein the failover edge node and the upgrade edge node are part of a collection of edge nodes that have a trust relationship.

In Example 18, the subject matter of Example 17 includes, wherein the trust relationship is formed on trust domain extensions (TDX), software guard extensions (SGX), or hardware security extensions.

Example 19 is at least one non-transitory machine-readable medium including instructions for upgrading network objects in an edge network the medium capable of storing instructions that, when executed by at least one processor, cause the at least one processor to perform operations to: receive an upgrade request to upgrade a target edge node in the edge network; identify building blocks of a package installed on the target edge node to be upgraded; store a state backup of the building blocks; transmit an upgrade command and an upgrade payload to the target edge node; query the target edge node to obtain a status of the target edge node; determine an upgrade action based on the status; and cause the upgrade action to be executed on the target edge node.

In Example 20, the subject matter of Example 19 includes, wherein the upgrade request includes an upgrade identifier.

In Example 21, the subject matter of Examples 19-20 includes, instructions that, when executed by at least one processor, cause the at least one processor to perform operations to obtain upgrade metadata that includes an identifier of the target edge node, the upgrade command, and the upgrade payload.

In Example 22, the subject matter of Examples 19-21 includes, wherein the building blocks are identified from the upgrade command.

In Example 23, the subject matter of Examples 19-22 includes, instructions that, when executed by at least one processor, cause the at least one processor to perform operations to: authenticate the target edge node; and transmit a request to upgrade to the target edge node, wherein the building blocks are identified upon receipt of a positive response to the request to upgrade.

In Example 24, the subject matter of Examples 19-23 includes, wherein the building blocks are software components of the package.

In Example 25, the subject matter of Examples 19-24 includes, wherein the state backup is stored in a storage device of a programmable networking device.

In Example 26, the subject matter of Examples 19-25 includes, instructions that, when executed by at least one processor, cause the at least one processor to perform operations to: determine that the upgrade command has timed out; and perform a rollback of a building block using the state backup, wherein the status includes a failure indicator for the building block.

In Example 27, the subject matter of Examples 19-26 includes, instructions that, when executed by at least one processor, cause the at least one processor to perform operations to: transmit a failover request to a failover node of the edge network, wherein the failover request includes an upgrade identifier and an identifier of the target edge node; set a failover flag for the upgrade of the target edge node; determine that the upgrade has completed; and reset the failover flag.

In Example 28, the subject matter of Examples 19-27 includes, wherein the upgrade request is a failover request transmitted by an upgrade edge node of the edge network and further including instructions that, when executed by at least one processor, cause the at least one processor to perform operations to: authenticate the upgrade edge node; store the failover request; and monitor an attempt by the upgrade edge node to perform the upgrade, wherein the instructions to identify the building blocks of the package installed on the target edge node to be upgraded are executed upon a determination that the attempt by the upgrade edge node to perform the upgrade has failed.

In Example 29, the subject matter of Example 28 includes, wherein the instructions to determine that the attempt by the upgrade edge node to perform the upgrade has failed comprises instructions to identify that no response has been received from the upgrade edge node in response to transmission of a status request.

In Example 30, the subject matter of Examples 28-29 includes, wherein the instructions to determine that the attempt by the upgrade edge node to perform the upgrade has failed comprises instructions to determine that a timeout period has elapsed for receiving a status update from the upgrade edge node.

In Example 31, the subject matter of Examples 28-30 includes, instructions that, when executed by at least one processor, cause the at least one processor to perform operations to: determine that the upgrade has completed; and delete the stored failover request.

In Example 32, the subject matter of Examples 19-31 includes, instructions that, when executed by the at least one processor, cause the at least one processor to perform operations to: identify the building blocks upon a determination that there a no critical workloads executing on the target edge node; and prevent the target edge node from accepting critical workloads until the status indicates the upgrade has completed.

In Example 33, the subject matter of Examples 19-32 includes, wherein the state backup of the building blocks includes rollback data to restore the current building block in the event of a failed upgrade attempt.

In Example 34, the subject matter of Examples 19-33 includes, wherein the upgrade action executes the upgrade command, performs a rollback of previously installed building blocks using the state backup, set a failover flag, or delete a stored failover request.

In Example 35, the subject matter of Examples 19-34 includes, wherein the target edge node and an upgrade edge node that causes the upgrade action to be executed on the target edge node are part of a collection of edge nodes that have a trust relationship.

In Example 36, the subject matter of Example 35 includes, wherein the trust relationship is established with a temporary upgrade trust domain.

In Example 37, the subject matter of Examples 35-36 includes, wherein the trust relationship is established with an upgrade trust domain, and wherein the target edge node is a member of a service delivery trust domain.

In Example 38, the subject matter of Examples 35-37 includes, wherein the trust relationship is formed on trust domain extensions (TDX), software guard extensions (SGX), or hardware security extensions.

Example 39 is a method for upgrading network objects in an edge network comprising: receiving an upgrade request to upgrade a target edge node in the edge network; identifying building blocks of a package installed on the target edge node to be upgraded; storing a state backup of the building blocks; transmitting an upgrade command and an upgrade payload to the target edge node querying the target edge node to obtain a status of the target edge node; determining an upgrade action based on the status; and causing the upgrade action to be executed on the target edge node.

In Example 40, the subject matter of Example 39 includes, wherein the upgrade request includes an upgrade identifier.

In Example 41, the subject matter of Examples 39-40 includes, obtaining upgrade metadata that includes an identifier of the target edge node, the upgrade command, and the upgrade payload.

In Example 42, the subject matter of Examples 39-41 includes, wherein the building blocks are identified from the upgrade command.

In Example 43, the subject matter of Examples 39-42 includes, authenticating the target edge node; and transmitting a request to upgrade to the target edge node, wherein the building blocks are identified upon receipt of a positive response to the request to upgrade.

In Example 44, the subject matter of Examples 39-43 includes, wherein the building blocks are software components of the package.

In Example 45, the subject matter of Examples 39-44 includes, wherein the state backup is stored in a storage device of a programmable networking device.

In Example 46, the subject matter of Examples 39-45 includes, determining that the upgrade command has timed out; and performing a rollback of a building block using the state backup, wherein the status includes a failure indicator for the building block.

In Example 47, the subject matter of Examples 39-46 includes, transmitting a failover request to a failover node of the edge network, wherein the failover request includes an upgrade identifier and an identifier of the target edge node; setting a failover flag for the upgrade of the target edge node; determining that the upgrade has completed; and resetting the failover flag.

In Example 48, the subject matter of Examples 39-47 includes, wherein the upgrade request is a failover request transmitted by an upgrade edge node of the edge network, the method further comprising: authenticating the upgrade edge node; storing the failover request; and monitoring an attempt by the upgrade edge node to perform the upgrade, wherein identifying the building blocks of the package installed on the target edge node to be upgraded is completed upon determining that the attempt by the upgrade edge node to perform the upgrade has failed.

In Example 49, the subject matter of Example 48 includes, wherein determining that the attempt by the upgrade edge node to perform the upgrade has failed comprises receiving no response from the upgrade edge node in response to transmission of a status request.

In Example 50, the subject matter of Examples 48-49 includes, wherein determining that the attempt by the upgrade edge node to perform the upgrade has failed comprises determining that a timeout period has elapsed for receiving a status update from the upgrade edge node.

In Example 51, the subject matter of Examples 48-50 includes, determining that the upgrade has completed; and deleting the stored failover request.

In Example 52, the subject matter of Examples 39-51 includes, identifying the building blocks upon a determination that there a no critical workloads executing on the target edge node; and preventing the target edge node from accepting critical workloads until the status indicates the upgrade has completed.

In Example 53, the subject matter of Examples 39-52 includes, wherein the state backup of the building blocks includes rollback data to restore the current building block in the event of a failed upgrade attempt.

In Example 54, the subject matter of Examples 39-53 includes, wherein the upgrade action executes the upgrade command, performs a rollback of previously installed building blocks using the state backup, set a failover flag, or delete a stored failover request.

In Example 55, the subject matter of Examples 47-54 includes, wherein the failover edge node and the upgrade edge node are part of a collection of edge nodes that have a trust relationship.

In Example 56, the subject matter of Example 55 includes, wherein the trust relationship is formed on trust domain extensions (TDX), software guard extensions (SGX), or hardware security extensions.

Example 57 is at least one machine-readable medium including instructions that, when executed by a machine, cause the machine to perform any method of Examples 39-56.

Example 58 is a system comprising means to perform any method of Examples 39-56.

Example 59 is a system for upgrading network objects in an edge network comprising: means for receiving an upgrade request to upgrade a target edge node in the edge network; means for identifying building blocks of a package installed on the target edge node to be upgraded; means for storing a state backup of the building blocks; means for transmitting an upgrade command and an upgrade payload to the target edge node means for querying the target edge node to obtain a status of the target edge node; means for determining an upgrade action based on the status; and means for causing the upgrade action to be executed on the target edge node.

In Example 60, the subject matter of Example 59 includes, wherein the upgrade request includes an upgrade identifier.

In Example 61, the subject matter of Examples 59-60 includes, means for obtaining upgrade metadata that includes an identifier of the target edge node, the upgrade command, and the upgrade payload.

In Example 62, the subject matter of Examples 59-61 includes, wherein the building blocks are identified from the upgrade command.

In Example 63, the subject matter of Examples 59-62 includes, means for authenticating the target edge node; and means for transmitting a request to upgrade to the target edge node, wherein the building blocks are identified upon receipt of a positive response to the request to upgrade.

In Example 64, the subject matter of Examples 59-63 includes, wherein the building blocks are software components of the package.

In Example 65, the subject matter of Examples 59-64 includes, wherein the state backup is stored in a storage device of a programmable networking device.

In Example 66, the subject matter of Examples 59-65 includes, means for determining that the upgrade command has timed out; and means for performing a rollback of a building block using the state backup, wherein the status includes a failure indicator for the building block.

In Example 67, the subject matter of Examples 59-66 includes, means for transmitting a failover request to a failover node of the edge network, wherein the failover request includes an upgrade identifier and an identifier of the target edge node; means for setting a failover flag for the upgrade of the target edge node; means for determining that the upgrade has completed; and means for resetting the failover flag.

In Example 68, the subject matter of Examples 59-67 includes, wherein the upgrade request is a failover request transmitted by an upgrade edge node of the edge network, the system further comprising: means for authenticating the upgrade edge node; means for storing the failover request; and means for monitoring an attempt by the upgrade edge node to perform the upgrade, wherein identifying the building blocks of the package installed on the target edge node to be upgraded is completed upon determining that the attempt by the upgrade edge node to perform the upgrade has failed.

In Example 69, the subject matter of Example 68 includes, wherein the means for determining that the attempt by the upgrade edge node to perform the upgrade has failed comprises means for receiving no response from the upgrade edge node in response to transmission of a status request.

In Example 70, the subject matter of Examples 68-69 includes, wherein the means for determining that the attempt by the upgrade edge node to perform the upgrade has failed comprises means for determining that a timeout period has elapsed for receiving a status update from the upgrade edge node.

In Example 71, the subject matter of Examples 68-70 includes, means for determining that the upgrade has completed; and means for deleting the stored failover request.

In Example 72, the subject matter of Examples 59-71 includes, means for identifying the building blocks upon a determination that there a no critical workloads executing on the target edge node; and means for preventing the target edge node from accepting critical workloads until the status indicates the upgrade has completed.

In Example 73, the subject matter of Examples 59-72 includes, wherein the state backup of the building blocks includes rollback data to restore the current building block in the event of a failed upgrade attempt.

In Example 74, the subject matter of Examples 59-73 includes, wherein the upgrade action executes the upgrade command, performs a rollback of previously installed building blocks using the state backup, set a failover flag, or delete a stored failover request.

In Example 75, the subject matter of Examples 67-74 includes, wherein the failover edge node and the upgrade edge node are part of a collection of edge nodes that have a trust relationship.

In Example 76, the subject matter of Example 75 includes, wherein the trust relationship is formed on trust domain extensions (TDX), software guard extensions (SGX), or hardware security extensions.

Example 77 is at least one machine-readable medium including instructions that, when executed by processing circuitry, cause the processing circuitry to perform operations to implement of any of Examples 1-76.

Example 78 is an apparatus comprising means to implement of any of Examples 1-76.

Example 79 is a system to implement of any of Examples 1-76.

Example 80 is a method to implement of any of Examples 1-76.

Example 81 is at least one machine-readable medium including instructions, which when executed by a machine, cause the machine to perform operations of any of the operations of Examples 1-76.

Example 82 is an apparatus comprising means for performing any of the operations of Examples 1-76.

Example 83 is a system to perform the operations of any of the Examples 1-76.

Example 84 is a method to perform the operations of any of the Examples 1-76.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A programmable networking device for upgrading network objects in an edge network comprising:
processing circuitry configured to:
receive, via the network interface, an upgrade request to upgrade a target edge node in the edge network;
identify building blocks of a package installed on the target edge node to be upgraded;
store a state backup of the building blocks;
transmit, via the network interface, an upgrade command and an upgrade payload to the target edge node;
query the target edge node to obtain a status of the target edge node;
determine an upgrade action based on the status; and
cause the upgrade action to be executed on the target edge node.

2. The programmable networking device of claim 1, wherein the upgrade request includes an upgrade identifier.

3. The programmable networking device of claim 1, further comprising processing circuitry configured to obtain upgrade metadata that includes an identifier of the target edge node, the upgrade command, and the upgrade payload.

4. The programmable networking device of claim 1, wherein the building blocks are identified from the upgrade command.

5. The programmable networking device of claim 1, further comprising processing circuitry configured to:
authenticate the target edge node; and
transmit a request to upgrade to the target edge node, wherein the building blocks are identified upon receipt of a positive response to the request to upgrade.

6. The programmable networking device of claim 1, further comprising processing circuitry configured to:
determine that the upgrade command has timed out; and
perform a rollback of a building block using the state backup, wherein the status includes a failure indicator for the building block.

7. The programmable networking device of claim 1, further comprising processing circuitry configured to:
transmit a failover request to a failover node of the edge network, wherein the failover request includes an upgrade identifier and an identifier of the target edge node;
set a failover flag for the upgrade of the target edge node;
determine that the upgrade has completed; and
reset the failover flag.

8. The programmable networking device of claim 1, wherein the upgrade request is a failover request transmitted by an upgrade edge node of the edge network and further comprising processing circuitry configured to:
authenticate the upgrade edge node;
store the failover request; and
monitor an attempt by the upgrade edge node to perform the upgrade, wherein the instruction to identify the building blocks of the package installed on the target edge node to be upgraded are executed upon determination that the attempt by the upgrade edge node to perform the upgrade has failed.

9. The programmable networking device of claim 8, wherein the processing circuitry configured to determine that the attempt by the upgrade edge node to perform the upgrade has failed further comprises comprising processing circuitry configured to determine that a timeout period has elapsed for receipt of a status update from the upgrade edge node.

10. The programmable networking device of claim 1, further comprising processing circuitry configured to:
identify the building blocks upon a determination that there a no critical workloads executing on the target edge node; and
prevent the target edge node from accepting critical workloads until the status indicates the upgrade has completed.

11. The programmable networking device of claim 1, wherein the state backup of the building blocks includes rollback data to restore the current building block in the event of a failed upgrade attempt.

12. The programmable networking device of claim 1, wherein the upgrade action executes the upgrade command, performs a rollback of previously installed building blocks using the state backup, set a failover flag, or delete a stored failover request.

13. At least one non-transitory machine-readable medium including instructions for upgrading network objects in an edge network the medium capable of storing instructions that, when executed by at least one processor, cause the at least one processor to perform operations to:
receive an upgrade request to upgrade a target edge node in the edge network;
identify building blocks of a package installed on the target edge node to be upgraded;
store a state backup of the building blocks;
transmit an upgrade command and an upgrade payload to the target edge node;
query the target edge node to obtain a status of the target edge node;
determine an upgrade action based on the status; and
cause the upgrade action to be executed on the target edge node.

14. The at least one non-transitory machine-readable medium of claim 13, further including instructions that, when executed by at least one processor, cause the at least one processor to perform operations to:
authenticate the target edge node; and
transmit a request to upgrade to the target edge node, wherein the building blocks are identified upon receipt of a positive response to the request to upgrade.

15. The at least one non-transitory machine-readable medium of claim 13, further including instructions that, when executed by at least one processor, cause the at least one processor to perform operations to:
transmit a failover request to a failover node of the edge network, wherein the failover request includes an upgrade identifier and an identifier of the target edge node;
set a failover flag for the upgrade of the target edge node;
determine that the upgrade has completed; and
reset the failover flag.

16. The at least one non-transitory machine-readable medium of claim 13, wherein the target edge node and an upgrade edge node that causes the upgrade action to be executed on the target edge node are part of a collection of edge nodes that have a trust relationship.

17. The at least one non-transitory machine-readable medium of claim 16, wherein the trust relationship is established with a temporary upgrade trust domain.

18. The at least one non-transitory machine-readable medium of claim 16, wherein the trust relationship is established with an upgrade trust domain, and wherein the target edge node is a member of a service delivery trust domain.

19. The at least one non-transitory machine-readable medium of claim 16, wherein the trust relationship is formed on trust domain extensions (TDX), software guard extensions (SGX), or hardware security extensions.

20. A method for upgrading network objects in an edge network comprising:
receiving an upgrade request to upgrade a target edge node in the edge network;
identifying building blocks of a package installed on the target edge node to be upgraded;
storing a state backup of the building blocks;
transmitting an upgrade command and an upgrade payload to the target edge node
querying the target edge node to obtain a status of the target edge node;
determining an upgrade action based on the status; and
causing the upgrade action to be executed on the target edge node.

21. The method of claim 20, further comprising:
authenticating the target edge node; and
transmitting a request to upgrade to the target edge node, wherein the building blocks are identified upon receipt of a positive response to the request to upgrade.

22. The method of claim 20, further comprising:
determining that the upgrade command has timed out; and
performing a rollback of a building block using the state backup, wherein the status includes a failure indicator for the building block.

23. The method of claim 20, further comprising:
transmitting a failover request to a failover node of the edge network, wherein the failover request includes an upgrade identifier and an identifier of the target edge node;
setting a failover flag for the upgrade of the target edge node;
determining that the upgrade has completed; and
resetting the failover flag.

24. The method of claim 20, wherein the upgrade request is a failover request transmitted by an upgrade edge node of the edge network, the method further comprising:
authenticating the upgrade edge node;
storing the failover request; and
monitoring an attempt by the upgrade edge node to perform the upgrade, wherein identifying the building blocks of the package installed on the target edge node to be upgraded is completed upon determining that the attempt by the upgrade edge node to perform the upgrade has failed.
